(19) United States
(12) Patent Application Publication
(10) Pub. No.: US 2018/0324253 A1
(43) Pub. Date: Nov. 8, 2018

(54) Information Sharing Across Multi-Device Systems

(71) Applicant: FROST NEWCO25, INC., San Juan Capistrano, CA (US)

(72) Inventors: Matthias Oberdorfer, La Mesa, CA (US); Chad Thomas, Ladera Ranch, CA (US)

(73) Assignee: FROST NEWCO25, INC.

(21) Appl. No.: 15/587,174

(22) Filed: May 4, 2017

(51) Int. Cl. H04L 29/08

(52) U.S. Cl. CPC H04L 67/12; H04W 84/18; H04L 67/16

(57) ABSTRACT

There are provided systems and methods for sharing information across multi-device systems. Such a system includes multiple device node communicatively coupled via a network. Each device node has a hardware processor and a memory storing an inter-node data transfer software code including a data transfer ledger. For each of the device nodes, its hardware processor is configured to execute the inter-node data transfer software code to receive an input data from a data source, process the input data to identify a relevant system data, and generate an output data based on the relevant system data. The inter-node data transfer software code is further executed to transmit the output data to one or more other device nodes, to generate a ledger entry for updating the data transfer ledger, and to broadcast the ledger entry to all others of the device nodes via the network.

### RELATED APPLICATION

This application is related to co-pending application Ser. No. 15/360,891, titled “Mediation of Data Exchange among Trusted Devices”, filed on Nov. 23, 2016, which is commonly assigned with the present application. The above-referenced related patent application is hereby incorporated fully by reference into the present application.

### BACKGROUND

Data sharing among network coupled systems and devices via communications channels such as the Internet of Things (IoT), for example, presents unprecedented possibilities for machine collaboration. For example, it is estimated that by 2020 there may be approximately fifty billion connected devices capable of participating in the IoT. Although those connected devices may be capable of sharing data in principle, in practice the extent to which such sharing occurs may be limited by several factors. For example, concerns about industrial espionage or cybercrime may inhibit communications between devices otherwise capable of sharing data. Moreover, the very abundance of the raw data collected across a widely distributed network may render the sharing of that data inefficient or ineffective. Consequently a solution for enabling information sharing among connected devices that is capable of increasing the efficiency, effectiveness, and security of machine collaboration is needed.

### SUMMARY

There are provided solutions for enabling information sharing across multi-device systems, substantially as shown in and/or described in connection with at least one of the figures, and as set forth more completely in the claims.

### BRIEF DESCRIPTION OF THE DRAWINGS

FIG. 1 shows a diagram of an exemplary solution for sharing information across a multi device system, according to one implementation;

FIG. 2 shows another exemplary implementation of a solution for sharing information across a multi-device system;

FIG. 3 shows a more detailed diagram of information sharing between two device nodes of a multi-device system, according to one implementation; and

FIG. 4 is a flowchart presenting an exemplary method for sharing information across a multi-device system.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, data sharing among network coupled systems and devices via communications channels such as the Internet of Things (IoT), for example, presents unprecedented possibilities for machine collaboration. As further noted above, although devices connected through the IoT or other networks may be capable of sharing data in principle, in practice the extent to which such sharing occurs may be limited by several factors. For example, concerns about industrial espionage or cybercrime may inhibit communications between devices otherwise capable of sharing data. Moreover, the very abundance of the raw data collected across a widely distributed network may render the sharing of that data inefficient or ineffective. Consequently a solution for enabling information sharing among connected devices that is capable of increasing the efficiency, effectiveness, and security of machine collaboration is needed.

The present application discloses systems and methods that address and overcome the deficiencies in the conventional art by enabling information sharing across multi-device systems. By processing data, such as raw input data, received by a device node of the multi-device system to identify relevant system data, the present solution enhances the efficiency and effectiveness with which information is shared among two or more device nodes of the system. Moreover, by broadcasting a ledger entry generated based on the sharing of information between any two device nodes to all other device nodes of the system, the present solution advantageously improves the way in which information sharing across the system is monitored and secured.

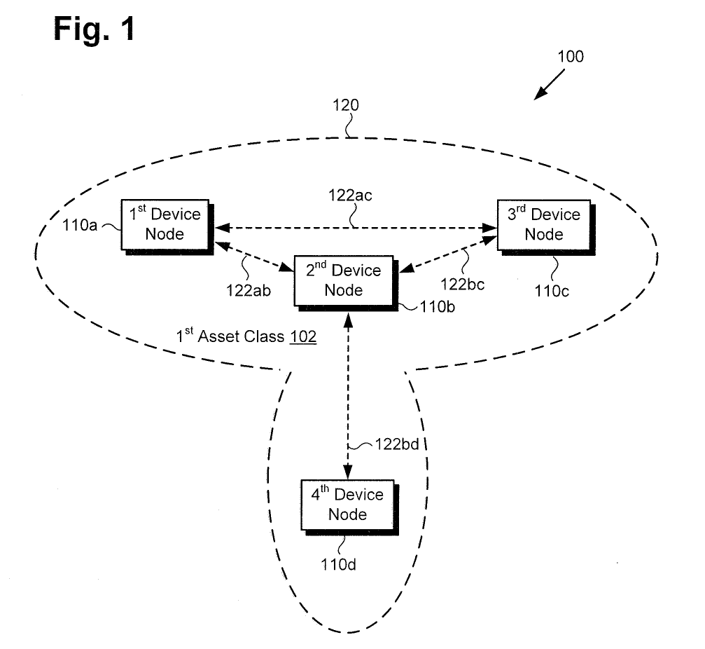

FIG. 1 shows a diagram of an exemplary solution for sharing information across a multi device system, according to one implementation. FIG. 1 shows system 100 including multiple device nodes of first asset class 102 communicatively coupled via network 120. As shown in FIG. 1, network 120 may be a peer-to-peer (P2P) network in which each of first device node 110a, second device node 110b, third device node 110c, and fourth device node 110d (hereinafter “device nodes 110a-110d”) is communicatively coupled to one or more others of device nodes 110a-110d via a direct wireless communication link.

Thus, according to the present exemplary implementation, first device node 110a and second device node 110b are communicatively coupled via direct wireless communication link 122ab, and first device node 110a and third device node 110c are communicatively coupled via direct wireless communication link 122ac, while second device node 110b and third device node 110c are communicatively coupled via direct wireless communication link 122bc. Also shown in FIG. 1 is fourth device node 110d, which is remote from first device node 110a and third device node 110c, but is communicatively coupled with second device node 110b via direct wireless communication link 122bd.

It is noted that, as defined in the present disclosure, an asset class, such as first asset class 102, refers to a group of device nodes that share one or more characteristics in common. Examples of such characteristics may include common ownership, common producer or originator, common assignment, the inclusion of parts in common, or common functionality, to name a few. That is to say, in some implementations, one or more of device nodes 110a-110d may correspond to devices that are structurally and/or functionally substantially identical, while in other implementations, device nodes 110a-110d may correspond to structurally and/or functionally distinct devices that are commonly owned or operated.

It is further noted that although FIG. 1 depicts device nodes 110a-110d as stationary device nodes, that representation is merely by way of example. In some implementations, one or more of device nodes 110a-110d may be in motion or may be configured to move relative to one or more others of device nodes 110a-110d. As specific but merely exemplary implementations, first asset class 102 may correspond to public safety assets of a municipality, or employee safety assets of a worksite. According to those exemplary implementations, first asset class 102 may include a traffic light corresponding to first device node 110a, an emergency response vehicle corresponding to second device node 110b, a fire/smoke detection system corresponding to third device node 110c, and a seismic sensing system corresponding to fourth device node 110d.

It is also noted that, although the implementation shown in FIG. 1 depicts system 100 as including four device nodes, i.e., device nodes 110a-110d, that representation is also merely exemplary. In practice, system 100 may include more, or many more, than four device nodes, such as tens, hundreds, thousands, or millions of device nodes, for example.

According to the exemplary implementation shown in FIG. 1, device nodes 110a-110d are communicatively coupled via direct wireless P2P network 120, and may thereby exchange and/or forward data or information across system 100. In some implementations, one or more of device nodes 110a-110d may be sufficiently remote from one or more others of device nodes 110a-110d for direct wireless communication between the remote device or devices and some others of device nodes 110a-110d to be impossible.

For example, and as shown in FIG. 1, system 100 includes fourth device node 110d, which is sufficiently remote from first device node 110a and third device node 110c so as to be unable to communicate directly with either of first or third device nodes 110a or 110c via a direct wireless communication link. However, according to the implementation shown in FIG. 1, fourth device node 110d is in direct wireless communication with second device node 110b via direct wireless communication link 122bd, and can consequently communicate with all device nodes of system 100 via direct wireless communication link 122bd and second device node 110b. In other words, and as shown by FIG. 1, second device node 110b can function as a repeater for remote fourth device node 110d, thereby advantageously expanding the reach of network 120 beyond the range of any single one of direct wireless communication links 122ab, 122ac, 122bc, or 122bd.

The wireless communication among device nodes 110a-110d corresponding to direct wireless communication links 122ab, 122ac, 122ab, and 122bd may be performed using any suitable wireless communications methods. For example, the wireless communications among device nodes 110a-110d may be performed via one or more of WiFi, Bluetooth, ZigBee, and 60 GHz wireless communications methods.

Thus, according to the implementation of system 100 shown in FIG. 1, each of device nodes 110a-110d can communicate with one or more others of device nodes 110a-110d directly, without the need for inter-node communication traffic to flow through one or more servers supporting a local area network (LAN), or supporting a wide area packet network such as the Internet. The direct wireless communication among device nodes 110a-110d provided by direct wireless communication links 122ab, 122ac, 122ab, and 122bd advantageously enables establishment of a consistent, accurate, and efficient P2P network connectivity. As a result, system 100 conserves network capacity, and reduces network traffic load, buffering, and delay when compared to server or local Access Point (AP) mediated communication network architectures.

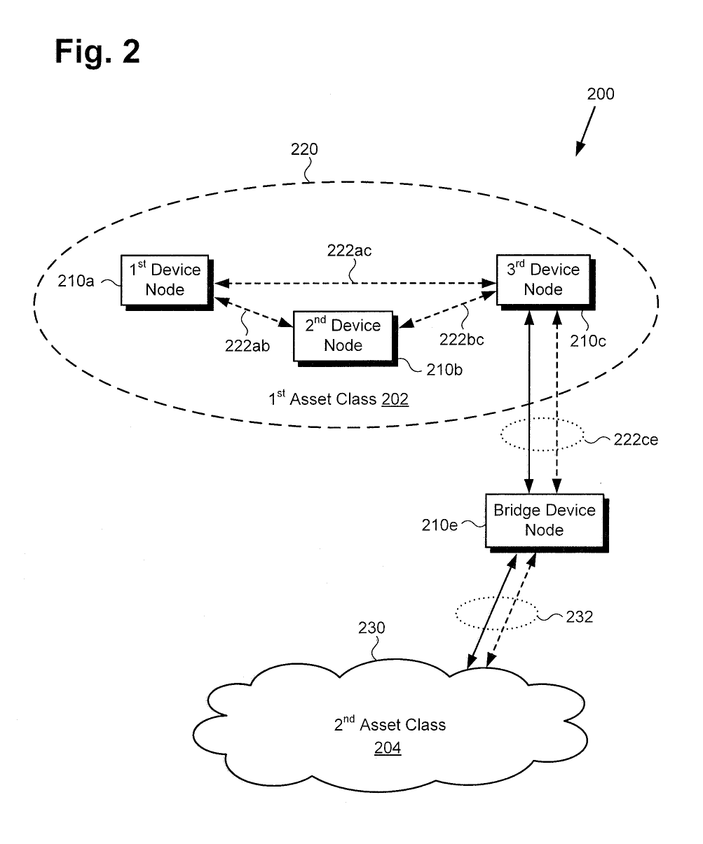

FIG. 2 shows another exemplary implementation of a solution for sharing information across a multi-device system. FIG. 2 shows system 200 including multiple device nodes of first asset class 202 communicatively coupled via network 220. As shown in FIG. 2, network 220 may be a P2P network in which each of first device node 210a, second device node 210b, and third device node 210c (hereinafter “device nodes 210a-210c”) is communicatively coupled to others of device nodes 210a-210c via a direct wireless communication link. According to the present exemplary implementation, first device node 210a and second device node 210b are communicatively coupled via direct wireless communication link 222ab, and first device node 210a and third device node 210c are communicatively coupled via direct wireless communication link 222ac, while second device node 210b and third device node 110c are communicatively coupled via direct wireless communication link 222bc.

System 200 further includes network 230 communicatively coupling second asset class 204 of device nodes, and bridge device node 210e coupling network 220 and network 230. FIG. 2 further illustrates wired or wireless communication link 222ce communicatively coupling network 220 with bridge device node 210e, and wired or wireless communication link 232 communicatively coupling network 230 with bridge device node 210e.

As noted above, an asset class, such as first asset class 202 and second asset class 204, refers to a group of device nodes that share one or more characteristics in common. As further noted above, examples of such characteristics may include common ownership, common producer or originator, common assignment, the inclusion of parts in common, or common functionality, to name a few. In other words, in some implementations, one or more of device nodes 210a-210c may correspond to devices that are structurally and/or functionally substantially identical, while in other implementations, device nodes 210a-210c may correspond to structurally and/or functionally distinct devices that are commonly owned or operated. Similarly, the device nodes included in second asset class 204 may be structurally and/or functionally distinct, or one or more of the device nodes of second asset class 204 may be structurally and/or functionally substantially identical to one another.

Network 220, first asset class 202, device nodes 210a-210c, and direct wireless communication links 222ab, 222ac, and 222bc correspond respectively in general to network 120, first asset class 102, device nodes 110a-110d, and direct wireless communication links 122ab, 122ac, 122bc, and 122bd, in FIG. 1, and may share any of the characteristics attributed to those corresponding features in the present application. Thus, like device nodes 110a-110d, device nodes 210a-210c may number in the tens, hundreds, thousands, or millions and may or may not be in motion relative to one or more others of device nodes 210a-210c. Moreover, like direct wireless communication links 122ab, 122ac, 122bc, and 122bd, the wireless communications provided by direct wireless communication links 222ab, 222ac, and 222bc may be performed via one or more of WiFi, Bluetooth, ZigBee, and 60 GHz wireless communications methods.

According to the exemplary implementation shown in FIG. 2, device nodes 210a-210c are communicatively coupled via direct wireless P2P network 220, and may thereby exchange and/or forward data or information to one another via network 220. In addition, the device nodes of second asset class 230 are communicatively coupled via network 230, which may be a direct wireless P2P network, a wired or wireless LAN, or a wired or wireless network using the Internet to mediate communications across network 230, for example. Furthermore, device nodes 210a-210c are communicatively coupled with the device nodes of network 230 via bridge device node 210e and communication links 222ce and 232.

Bridge device node 210e may correspond to a device belonging to both of first asset class 202 and second asset class 204. Moreover, bridge device node 210e may be in direct communication with one or more of device nodes 210a-210c, as well as with one or more device nodes of network 230. As noted above, communication link 222ce and/or communication link 232 may be wired or wireless communication links. When implemented as wireless communication links, communication links 222ce and communication link 232 may be direct wireless communication links providing communications via one or more of WiFi, Bluetooth, ZigBee, and 60 GHz wireless communications methods.

In some implementations, bridge device node 210e may be sufficiently remote from one or more of device nodes 210a-210c and/or one or more of the device nodes of network 230 for direct wireless communication between bridge device node 210e and some others of device nodes 210a-210c and/or device nodes of network 230 to be impossible. For example, and as shown in FIG. 2, bridge device node 210e is sufficiently remote from first device node 210a and second device node 210b so as to be unable to communicate directly with either of first or second device nodes 210a or 210b.

However, according to the implementation shown in FIG. 2, bridge device node 210e is in communication with third device node 210c via communication link 222ce, and can consequently communicate with all of device nodes 210a-210d of network 220 via communication link 122ce and third device node 210c. Moreover, bridge node 210e can analogously communicate with all device nodes of network 230 via communication link 232 and one or more of the device nodes of network 230. Consequently, and as shown by FIG. 2, each device node of system 200, i.e., device nodes 210a-210c, 210e, and the device nodes of network 230, can advantageously communicate with all other device nodes of system 200.

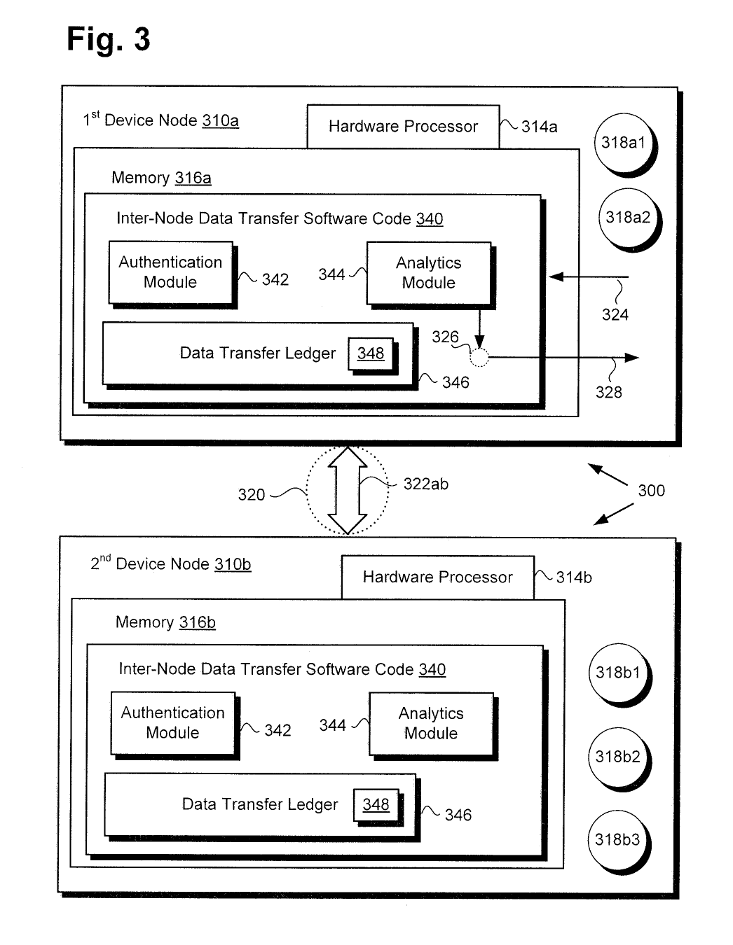

Continuing to FIG. 3, FIG. 3 shows a more detailed diagram of information sharing between two device nodes of a multi-device system, according to one implementation. System 300 includes first device node 310a and second device node 310b communicatively coupled via direct wireless communication link 322ab of network 320.

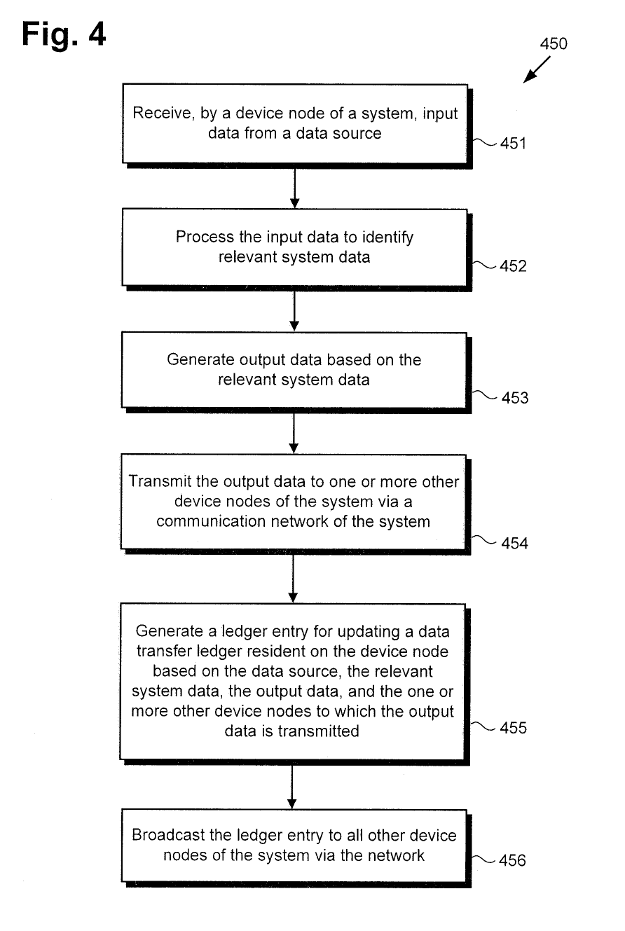

As shown in FIG. 3, device node 310a includes hardware processor 314a, and memory 316a storing inter-node data transfer software code 340. As further shown in FIG. 3, device node 310b includes hardware processor 314b, and memory 316b also storing inter-node data transfer software code 340. Inter-node data transfer software code 340 includes authentication module 342, analytics module 344, and data transfer ledger 346 including ledger entry 348. In addition, FIG. 3 shows exemplary input data 324, relevant system data 326, and output data 328, which are described in greater detail be reference to FIG. 4, below. Also shown in FIG. 3 are sensors 318a1 and 318a2 (hereinafter “sensors 318a1-318a2”) of device node 310a, and sensors 318b1, 318b2, and 318b3 (hereinafter “sensors 318b1-318b3”) of device node 310b.

System 300 and network 320 including direct wireless communication link 322ab correspond in general to system 100/200 and network 120/220 including direct wireless link 122ab/222ab, in FIG. 1/2, and may share any of the characteristics attributed to those corresponding features in the present disclosure. In addition, first device node 310a and second device node 310b, in FIG. 3, correspond respectively in general to first device node 110a/210a and second device node 110b/210b, in FIG. 1/2.

More generally, each of the device nodes of FIGS. 1 and 2, i.e., device nodes 110a-110d, device nodes 210a-210c, bridge device node 210e, and the device nodes of network 230, correspond in general to first and second device nodes 310a and 310b and may share any of the characteristics attributed to first and second device nodes 310a and 310b in the present disclosure. In other words, each of device nodes 110a-110d, device nodes 210a-210c, bridge device node 210e, and the device nodes of network 230 may include a hardware processor corresponding to hardware processor 314a/314b, and a memory corresponding to memory 316a/316b and storing inter-node data transfer software code 340. It is noted that hardware processor 314a/314b may be the central processing unit (CPU) for device node 310a/310b, for example, in which role hardware processor 314a/314b executes inter-node data transfer software code 340 to enable the efficient, effective, and secure sharing of information across the multiple device nodes of system 100/200/300.

Systems 100, 200, and 300 discussed above by reference to respective FIGS. 1, 2, and 3, will be further described below with reference to FIG. 4. FIG. 4 presents flowchart 450 outlining an exemplary method for sharing information across a multi-device system. It is noted that the exemplary method outlined by flowchart 450 may be performed by each of the device nodes of systems 100, 200, and 300. However, in the interests of conceptual clarity, the actions of the present method will be described by reference to first device node 110a/210a/310a. Thus input data 324, relevant system data 326, and output data 328, in FIG. 3, may be features of any device node of systems 100, 200, and 300, despite being shown explicitly as features of first device node 110a/210a/310a.

Flowchart 450 begins with receiving input data 324 from a data source (action 451). Input data 324 may be received by inter-node data transfer software code 340 of first device node 110a/210a/310a, executed by hardware processor 314a. Input data 324 may include a wide variety of data types. For example, input data 324 may include sensor data received from one or more of sensors 318a1-318a2 of first device node 110a/210a/310a. Thus, one or more of sensors 318a1-318a2 of first device node 110a/210a/310a may be data sources from which input data 324 is received.

Input data 324 may include environmental data, such as local weather data for an environment surrounding first device node 110a/210a/310a, or performance and/or diagnostic data for first device node 110a/210a/310a. For instance, input data 324 may correspond to the performance and/or environment of a vehicle corresponding to first device node 110a/210a/310a, or to alarm data generated by a smoke/fire detection system corresponding to one or both of sensors 318a1-318a2, or in response to a malfunction by first device node 110a/210a/310a.

Alternatively, or in addition, input data 324 may include sensor data received from any other device node of system 100/200/300, such as one or more of sensors 318b1-318b3 of second device node 110b/210b/310b. In other words, one or more of sensors 318b1-318b3 may be data sources from which input data 324 is received.

Where input data 324 is received from another device node, such as second device node 110b/210b/310b, input data 324 may be received over direct wireless communication link 122ab/222ab/322ab of P2P network 120/220/320. Moreover, where input data 324 is received from second device node 110b/210b/310b, hardware processor 314a may further execute inter-node data transfer software code 340 of first device node 110a/210a/310a to authenticate second device node 110b/210b/310b as a trusted data source before taking action on input data 324. Authentication of second device node 110b/210b/310b as a trusted source of input data 324 may be performed by inter-node data transfer software code 340 of first device node 110a/210a/310a, using authentication module 342.

Flowchart 450 continues with processing input data 324 to identify relevant system data 326 (action 452). It is noted that much of input data 324 received by inter-node data transfer software code 340 of first device node 110a/210a/310a may be innocuous. For example, environmental, performance, or sensor data that is received routinely and is itself inconsequential may be logged or otherwise noted by inter-node data transfer software code 340 of first device node 110a/210a/310a, but need not be shared with other device nodes of system 100/200/300. In fact selectively declining to share input data that is routine or innocuous with other device nodes of system 100/200/300, by inter-node data transfer software code 340 of first device node 110a/210a/310a, advantageously conserves network capacity, and reduces network traffic load, buffering, and delay for system 100/200/300, thereby preserving network resources for the sharing of relevant system data 326.

Relevant system data 326 may be identified by inter-node data transfer software code 340 of first device node 110a/210a/310a, executed by hardware processor 314a, and using analytics module 344. Examples of relevant system data 326 include an alert, an alarm, and a request for information from one or more other device nodes of system 100/200/300. An alert or alarm may be generated by one or more of sensors 318a1-318a2 of first device node 110a/210a/310a itself, for example.

Alternatively, or in addition, an alert or alarm may be received by inter-node data transfer software code 340 of first device node 110a/210a/310a from one or more sensors of another device node, such as one or more of sensors 318b1-318b3 of second device node 110b/210b/310b. As noted above, in instances in which input data 324 is received at first device node 110a/210a/310a from another device node, such as second device node 110b/210b/310b, inter-node data transfer software code 340 of first device node 110a/210a/310a may authenticate second device node 110b/210b/310b as a trusted source of input data 324 before processing input data 324 to identify relevant system data 326.

Flowchart 450 continues with generating output data 328 based on relevant system data 326 (action 453). In some implementations, generating output data 328 may include modifying relevant system data 326 prior to sharing relevant system data 326 with one or more other device nodes of system 100/200/300.

For example, inter-node data transfer software code 340 may specifically adapt relevant system data 326 for use by another device node, such as second device node 110b/210b/320b, based on a known device profile, characteristics, or resource limitations of second device node 110b/210b/320b. Moreover, in some implementations, generating output data 328 may include generating new data for use by second device node 110b/210b/320b based on relevant system data 326. Output data 328 may be generated by inter-node data transfer software code 340 of first device node 110a/210a/310a, executed by hardware processor 314a.

Flowchart 450 continues with transmitting output data 328 to one or more other device nodes of system 100/200/300 via network 120/220/230/320 (action 454). The transmission of output data 328 may be performed by inter-node data transfer software code 340 of first device node 110a/210a/310a, executed by hardware processor 314a. For example, one or more other device nodes of system 100/200/300, such as second device node 110b/210b/310b, may be identified as a potentially desirous recipient or recipients of output data 328 based on their location, function, or device profile. Output data 328 may take the form of an alert, an alarm, or a request for information, for example.

In some implementations, one or more other device nodes of system 100/200/300, such as second device node 110b/210b/310b, may self identify as a desirous recipient of output data 328, due to being a source of input data 324, for example. As a specific example, where relevant system data 326 is a request for information identified from input data 324 received from second device node 110b/210b/310b, output data 328 may be a response to the request for information from second device node 110b/210b/310b. Output data 328 may be transmitted from first device node 110a/210a/310a over direct wireless communication link 122ab/222ab/322ab of P2P network 120/220/320, for example.

Flowchart 450 continues with generating ledger entry 348 for updating data transfer ledger 346 based on the source of input data 324, relevant system data 326, output data 328, and the one or more other device nodes of system 100/200/300 to which output data 328 is transmitted (action 455). Ledger entry 348 may be generated in data transfer ledger 346 stored in memory 316a of first device node 110a/210a/310a by inter-node data transfer software code 340 of first device node 110a/210a/310a, executed by hardware processor 314a. Data transfer ledger 346 may be a Blockchain type transaction ledger for tracking the sharing of system information between or among device nodes of system 100/200/300.

Flowchart 450 may conclude with broadcasting ledger entry 348 to all device nodes of system 100/200/300 via network 120/220/230/320 (action 456). As shown by FIG. 3, broadcasting of ledger entry 348 to other device nodes of system 100/200/300, such as second device node 110b/210b/310b, results in data transfer ledger 348, which is a distributed ledger persistently stored on each of the device nodes of system 100/200/300, being updated in real-time. That is to say, ledger entry 348, generated in response to sharing of system information by first device node 110a/210a/310a with one or more other device nodes of system 100/200/300, can be propagated into each version of distributed data transfer ledger 346, such as data transfer ledger 346 stored in memory 316b of second device node 110b/210b/310b, substantially concurrently.

Ledger entry 348 may be broadcast between first device node 110a/210a/210b and second device node 110b/210b/310b, for example, via network 120/220/320, using direct wireless communication links 122ab/222ab/322ab. Broadcasting of ledger entry 348 to all device nodes of system 100/200/300 via network 120/220/230/320 may be performed by inter-node data transfer software code 340 of first device node 110a/210a/310a, executed by hardware processor 314a.

Thus, the present application discloses systems and methods for enabling information sharing across multi-device systems. By processing data, such as raw input data, received by a device node of the multi-device system to identify relevant system data, the present solution enhances the efficiency and effectiveness with which information is shared among two or more device nodes of the system. Moreover, by broadcasting a ledger entry generated based on the sharing of information between any two device nodes to all other device nodes of the system, the present solution advantageously improves the way in which information sharing across the system is monitored and secured.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a plurality of device nodes communicatively coupled via a network;
each of the plurality of device nodes including a respective hardware processor and a respective memory storing an inter-node data transfer software code including a data transfer ledger;
wherein for each of the device nodes, the respective hardware processor is configured to execute the inter-node data transfer software code to:
receive an input data from a data source;
process the input data to identify a relevant system data;
generate an output data based on the relevant system data;
transmit the output data to at least one other of the plurality of device nodes;
generate a ledger entry for updating the data transfer ledger based on the data source, the relevant system data, the output data, and the at least one other of the plurality of device nodes; and
broadcast the ledger entry to all others of the plurality of device nodes via the network.

2. The system of claim 1, wherein the data source comprises a sensor.

3. The system of claim 1, wherein each of the device nodes includes a respective at least one sensor, and wherein the data source is one or more of the at least one sensor.

4. The system of claim 1, wherein the data source is another one of the plurality of device nodes, and wherein the hardware processor is further configured to execute the inter-node data transfer software code to authenticate the data source before processing the input data.

5. The system of claim 1, wherein the data source is another one of the plurality of device nodes, and wherein the at least one other of the plurality of device nodes to which the output data is transmitted is the data source.

6. The system of claim 1, wherein the plurality of device nodes are configured for wireless communication via the network.

7. The system of claim 1, wherein the plurality of device nodes are configured to communicate using at least one of WiFi, Bluetooth, ZigBee, and 60 GHz wireless communication.

8. The system of claim 1, wherein the network is a peer-to-peer network of the plurality of device nodes.

9. The system of claim 1, wherein the relevant system data comprises one of an alert, an alarm, and a request for information from one or more others of the plurality of device nodes.

10. The system of claim 1, wherein the output data comprises one of an alert, an alarm, a request for information, and a response to a request for information from one or more others of the plurality of device nodes.

11. A method for use by each of a plurality of device nodes communicatively coupled via a network, wherein each of the plurality of device nodes includes a respective hardware processor and a respective memory storing an inter-node data transfer software code including a data transfer ledger, the method comprising:
receiving, using the respective hardware processor, an input data from a data source;
processing, using the hardware processor, the input data to identify a relevant system data;
generating, using the hardware processor, an output data based on the relevant system data;
transmitting, using the hardware processor, the output data to at least one other of the plurality of device nodes;
generating, using the hardware processor, a ledger entry for updating the data transfer ledger based on the data source, the relevant system data, the output data, and the at least one other of the plurality of device nodes; and
broadcasting, using the hardware processor, the ledger entry to all others of the plurality of device nodes via the network.

12. The method of claim 11, wherein the data source comprises a sensor.

13. The method of claim 11, wherein each of the device nodes includes a respective at least one sensor, and wherein the data source is one or more of the at least one sensor.

14. The method of claim 11, wherein the data source is another one of the plurality of device nodes, and wherein the method further comprises authenticating, using the hardware processor, the data source before processing the input data.

15. The method of claim 11, wherein the data source is another one of the plurality of device nodes, and wherein the at least one other of the plurality of device nodes to which the output data is transmitted is the data source.

16. The method of claim 11, wherein the plurality of device nodes are configured for wireless communication via the network.

17. The method of claim 11, wherein the plurality of device nodes are configured to communicate using at least one of WiFi, Bluetooth, ZigBee, and 60 GHz wireless communication.

18. The method of claim 11, wherein the network is a peer-to-peer network of the plurality of device nodes.

19. The method of claim 11, wherein the relevant system data comprises one of an alert, an alarm, and a request for information from one or more others of the plurality of device nodes.

20. The method of claim 11, wherein the output data comprises one of an alert, an alarm, a request for information, and a response to a request for information from one or more others of the plurality of device nodes.
